(19) United States
(12) Patent Application Publication
(10) Pub. No.: US 2016/0329948 A1
(43) Pub. Date: Nov. 10, 2016

(54) RANGE EXTENDER FOR MOBILE COMMUNICATION NETWORK

(71) Applicant: HIRSCHMANN CAR COMMUNICATION GMBH, Neckartenzlingen (DE)

(72) Inventors: Markus PFLETSCHINGER, Eningen (DE); Dominik SCHAICH, Neckarhausen (DE); Patrick KUTSCHAT, Lenningen (DE)

(21) Appl. No.: 15/036,356

(22) PCT Filed: Jan. 27, 2015
(86) PCT No.: PCT/EP2015/051560

§ 371 Date: May 12, 2016

(30) Foreign Application Priority Data
Jan. 27, 2014 (DE) 10 2014 201 405.0

(51) Int. Cl. H04B 7/08

(52) U.S. Cl. CPC H04B 7/08

(57) ABSTRACT

Disclosed is a multiple antenna system for vehicles, comprising two or more antennas (1, 4) for receiving high-frequency signals. The at least two antennas (1, 4) are connected to at least one receiver device (2) via reception paths. Said multiple antenna system is characterized in that a low-noise amplifier (5) is inserted into a reception path of at least one antenna (1, 4) and into the receiver device (2).

### CROSS REFERENCE TO RELATED APPLICATIONS

This application is the US-national stage of PCT application PCT/EP2015/051560 filed 27 Jan. 2015 and claiming the priority of German patent application 102014201405.0 itself filed 27 Jan. 2014.

### FIELD OF THE INVENTION

The invention relates to a multiple antenna system for a motor vehicle, a vehicle with such a multiple antenna system and a method of operating a multiple antenna system for a motor vehicle provided with at least two antennas that receive signals and at least one receiver to which the two antennas are connected by respective reception paths.

### BACKGROUND OF THE INVENTION

Mobile devices such as for example mobile telephones, tablets and multimedia devices are increasingly being connected to the internet by wireless technology such as for example GSM, HSDPA, LTE or WLAN. For this technology, complete modules or chip sets are inserted into the devices. So-called MISO systems have become established for transmission purposes. These are Multiple Input Single Output systems (see FIG. 1A).

In order to obtain an optimal connection with a high data rate even in poorly serviced areas, the transmission power could be increased. This is not permitted by law and would also consume significantly more energy.

With fast data connections, a multichannel transmission is used (FIG. 1B) that employs an antenna for transmission and reception and a further receive-only antenna (diversity antenna). In the less data-intensive uplink these MISO systems use a secure transmission and modulation method, such as for example SC-FDMA that also spares the battery of the mobile device. In the data-rich downlink diversity is employed as well as a dynamic modulation method optimized for maximum data throughput. High modulation, such as for example 64 QAM, can only be used under optimal reception conditions. When conditions are poor, the system switches over to QPSK (4 QAM), which results in a significantly lower data throughput.

### OBJECT OF THE INVENTION

The object of the invention is to improve the wireless connection within the existing statutory framework requirements, in order thus to obtain better data transmission rates and to close coverage gaps.

### SUMMARY OF THE INVENTION

In the multiple antenna system for a motor vehicle according to the invention, a low-noise amplifier is inserted in a reception path between at least one of the antennas and the receiver.

Since the wireless modules do not have any optimal input stages, the reception sensitivity can be substantially increased by a LNA (low noise amplifier) connected upstream in the reception path. In practice this improvement has an astonishing effect on the data rate and the availability of the network connection even in poorly serviced areas. Thus coverage gaps are closed and the maximum download rate is multiplied without departing from the statutory framework conditions.

A low-noise amplifier (LNA) is a special type of electronic amplifier that in terms of circuitry is characterized by particularly low noise, in order to amplify extremely weak signals. The noise figure is a special parameter of a LNA.

When modems are installed in motor vehicles, the roof antenna is generally used as a transmitting and receiving antenna. The second diversity antenna is concealed in the bumper or the window or behind electrically nonconductive accessories. This results in antenna levels that differ considerably, since the exposed position of the roof antenna enables a better level of reception. In order to compensate for the poorer reception level of the second antenna, an amplifier is advantageously connected downstream of this antenna.

The amplifier can also be mounted directly at the foot of the receiving antenna, and thus the S/N (signal to noise) ratio is not unnecessarily attenuated due to interference from the cable.

Furthermore, a vehicle with a multiple antenna system as described above is provided in order to achieve the object and the at least one antenna together with the respective low-noise amplifier is in a window of the vehicle. Above all when the low-noise amplifier is directly at the base of the respective antenna, in an advantageous manner not only can the available installation space be optimally utilized but also the functioning of the low-noise amplifier can be used optimally, since only short signal paths are necessary. Alternatively or also, the at least one antenna together with the respective low-noise amplifier is on a bumper of the vehicle. In the case of single reception of high-frequency signals there are two alternative installation spaces for mounting the at least one antenna with the respective low-noise amplifier. Furthermore, of course other installation spaces are also conceivable (such as for example the vehicle roof or other suitable installation sites in the vehicle or on the vehicle or outside of the vehicle). Finally, two similar or different installation spaces can be provided mounting the antenna with the respective amplifier. Thus for example respective antennas with the respective low-noise amplifier can be mounted in the left and right corners of a bumper. The same also applies to the window, where, as also in the event of arrangement on a bumper or at a different installation site, one or two or more antennas with respective low-noise amplifiers can be provided.

In a modification of the invention the at least one antenna is transparent. This has the advantage that the antenna can be integrated on the vehicle window (or even in the vehicle window), but without restricting the view through the vehicle window. Of course, the antenna is made of a material that still enables high-frequency signals to be received (and/or also to be transmitted, if applicable).

As a further means for achieving the object a method is provided for operating a multiple antenna system for a motor vehicle where a low-noise amplifier is inserted in a reception path between at least one antenna and the receiver. In a particularly advantageous manner the amplifier is bridged as a function of the field strength of the received high-frequency signals. In the event of good service and thus high field strength, too much amplification in the reception path may be disruptive. If this occurs, the amplifier can be selectively bypassed (bridged).

In a modification of the invention the amplifier is remote-fed and/or remote-controlled by a cable, in particular a HF cable. If the amplifier is an active amplifier and if its components require a power supply in order for it to function, when such an amplifier is used and when the multiple antenna system is operated in the vehicle it is particularly advantageous if the amplifier is fed by a cable from the power supply of the vehicle. Since the power supply (battery or the like) of the vehicle and the installation site of the amplifier differ from one another, remote feeding via a cable is advantageous.

Since, as described above, the high-frequency signals received by the one antenna are delivered to the amplifier and then to the receiver, in the receiver the (high-frequency or intermediate-frequency or low-frequency) signal delivered to the receiver can be evaluated and controlled (or switched) as a function of the evaluation of the amplifier.

### BRIEF DESCRIPTION OF THE DRAWING

A multiple antenna system for a motor vehicle, a corresponding vehicle as well as the method of operating the multiple antenna system are described below with reference to the drawings in which:

FIGS. 1A and 1B illustrate the prior art;

FIG. 2 is a schematic view of a vehicle incorporating the antenna system of this invention; and

FIG. 3 is a schematic view of a detail of the invention.

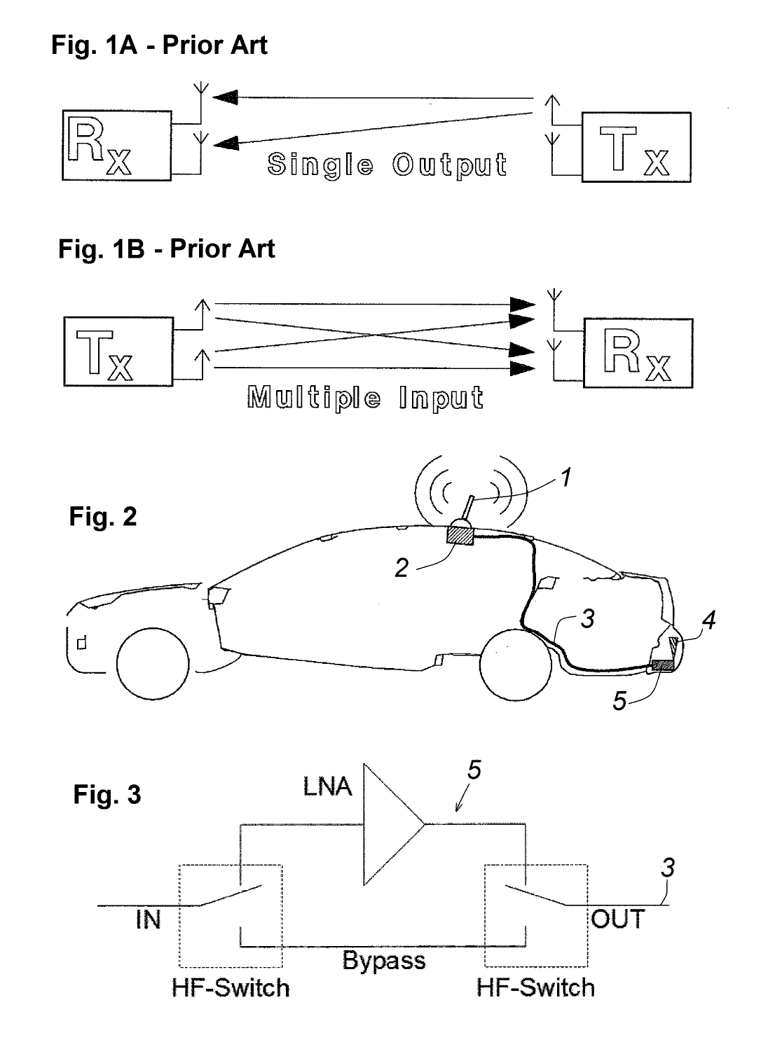

### SPECIFIC DESCRIPTION OF THE INVENTION

FIG. 2 shows an example of a layout of a multiple antenna system in a vehicle. Two antennas 1 and 4 that receive high-frequency signals are provided at different installation sites. These are for example a main antenna 1 for transmitting and/or receiving as well as a second receive-only antenna 4. A LTE wireless module with diversity system is provided for example as a receiver 2. However, any other receivers can also be used. The second antenna 4 is connected by a HF cable 3 to the receiver 2, and the main antenna 1 is connected directly to the receiver 2. However, it is also conceivable for the receiver 2 to be at a different installation site inside the vehicle and for both antennas 1 and 4 to be connected by respective cables to the receiver 2.

In accordance with the invention, FIG. 2 shows that the second antenna 4 (or alternatively or also the main antenna 1 or, if applicable, further antennas) is connected to a low-noise amplifier 5. In this embodiment the low-noise amplifier 5 sits directly at the base of the antenna 4, as only illustrated schematically in FIG. 2. Such a low-noise amplifier can also be provided on the main antenna 1. The second antenna 4 with its respective low-noise amplifier 5 is on a bumper of the illustrated vehicle, this installation site being preferably used because it offers good reception characteristics and the presence of the antenna can be made invisible here. It is also conceivable for the at least one antenna to be integrated into other components of the vehicle that are made of a nonmetallic material (such as for example vehicle windows, vehicle roof, bonnet, convertible top or the like) or also are integrated, for example, not inside a hollow space in the bumper, but in the bumper itself that may be made of plastic. Whereas FIG. 2 shows that the low-noise amplifier 5 is directly at the base of the respective antenna 4, it is also conceivable to connect the at least one antenna by a cable to the low-noise amplifier 5 and to connect it in turn by a further cable (such as the HF cable 3 in the embodiment according to FIG. 3) to the receiver 2. Depending upon the conditions of the installation space, such an arrangement may be necessary if the low-noise amplifier cannot be accommodated directly in the installation space for the respective antenna. In this case, however, it should be ensured that the cable connection between the low-noise amplifier 5 and the respective antenna 4 is kept as short as possible.

In a particularly advantageous manner, as shown in FIG. 3, the amplifier is bridged as a function of the field strength of the received high-frequency signals. In the event of good service and thus a high field strength, too much amplification in the reception path may be disruptive. If this situation occurs, the amplifier can be circumvented by a bypass switch (in particular HF switches) connected upstream or downstream thereof.

The invention relates to the improvement of a multiple antenna reception system for terminal equipment such as for example hotspots in the motor vehicle (the LNA is particularly important here), smart phones, multimedia devices and tablets that are connected by a wireless connection to a base station or to a router.

1. In a multiple antenna system for a motor vehicle in which two antennas are provided that receive signals and at least one receiver is provided to which the at least two antennas are connected by reception paths, the improvement comprising:
a low-noise amplifier in a reception path between one antenna and the receiver.

2. The multiple antenna system according to claim 1, wherein the low-noise amplifier is directly at a base of the one antenna.

3. A vehicle having a multiple antenna system according to claim 1, wherein the one antenna together with the respective low-noise amplifier is in a window of the vehicle.

4. The vehicle having a multiple antenna system according to claim 1, wherein the at least one antenna together with the respective low-noise amplifier is on a bumper of the vehicle.

5. The vehicle having a multiple antenna system according to claim 3, wherein the at least one antenna is transparent.

6. A method of operating a multiple antenna system for a motor vehicle in which two antennas are provided that receive signals and at least one receiver is provided to which the at least two antennas are connected by respective reception paths, the method comprising the step of providing a low-noise amplifier is inserted in a reception path between at least one of the antennas and the receiver.

7. The method according to claim 6, further comprising the step of:
bridging the amplifier by a switchable bypass operable as a function of the field strength of the received high-frequency signals.

8. The method according to claim 6, further comprising the step of: further comprising the step of:
controlling the amplifier.

9. The method according to claim 8, wherein the amplifier is controlled as a function of the field strength of the received high-frequency signals.

10. The method according to claim 8, wherein the amplifier is controlled by being bypassed.

11. An antenna system for a motor vehicle, the system comprising:
two separate antennas;
a receiver;
respective reception paths connecting the antennas to the receiver;
a low-noise amplifier in one of the paths for amplifying a signal therein;
means for detecting signal strength in the one path; and
a bypass connected to the detecting means for bypassing the amplifier when the detected signal strength exceeds a predetermined limit.
